(19) United States
(12) Patent Application Publication
(10) Pub. No.: US 2008/0208941 A1
(43) Pub. Date: Aug. 28, 2008

(54) Interpolation Process Circuit

(75) Inventor: Yukio Koyanagi, Saitama (JP)

Correspondence Address: CONNOLLY BOVE LODGE & HUTZ LLP, 1875 EYE STREET, N.W., SUITE 1100, WASHINGTON, DC, 20036, US

(73) Assignee: Neuro Solutiion Corp., Tokyo (JP)

(21) Appl. No.: 11/915,085

(22) PCT Filed: Feb. 8, 2006
(86) PCT No.: PCT/JP2006/302576

§ 371 Date: Nov. 20, 2007

(30) Foreign Application Priority Data
Jun. 16, 2005 (JP) 2005-176056

(51) Int. Cl. G06F 17/17

(52) U.S. Cl. 708/313

(57) ABSTRACT

There are included a three-tap FIR calculating part (2) that multiples data outputted from three taps on a tapped delay line by respective filter factors comprising a ratio value sequence of “−1, m, −1”; and an n-tap FIR calculating part (3) that multiples data outputted from n taps on a tapped delay line by respective filter factors comprising a predetermined value sequence. Interpolation values can be determined by use of sum-of-products calculations using various factor sequences comprising various values of m and n. The three-tap FIR calculating part (2) is adapted to determine interpolation values by use of the sum-of-products calculations that always use only three values. In this way, the circuit scale can be reduced and further the calculation process can be simplified, thereby achieving a high-rate interpolation process.

### CROSS REFERENCE TO RELATED APPLICATION

This application is a national stage application (under 35 U.S.C. § 371) of PCT/JP2006/302576 filed Feb. 8, 2006, which claims benefit of Japanese Application No. 2005-176056 filed Jun. 16, 2006, disclosure of which is incorporated herein by reference.

### TECHNICAL FIELD

The present invention relates to an interpolation process circuit and, in particular, to an interpolation process circuit utilizing an FIR digital filter of the type that multiplies each tap signal by given filter coefficients on a tapped delay line made up of a plurality of delay devices, and then outputs the sum of these products.

### BACKGROUND ART

In the prior art, a method by which pixel interpolation is used to increase the number of pixels and thereby increase horizontal and vertical resolution in order to improve the quality of a television picture is well-known. For this purpose, an image processing circuit which performs horizontal direction interpolation process and vertical direction interpolation process at high speed using hardware made up of simple circuits without using processors or the like has been proposed (in patent document 1, for instance).

Patent document 1: Japanese Patent Laid-Open No. 2000-148061

The image processing circuit disclosed in patent document 1, in an image for which the sampling frequency is an integer multiple of a line frequency, calculates a pixel value for an interpolating pixel that sits on a straight line connecting the two adjacent pixels which align diagonally at proximal positions sandwiching the focused pixel by averaging the pixel values of the focused pixel and the two adjacent pixels. Thus when performing interpolation process, it is possible to obtain a pixel value for the interpolating pixel using only three pixel values and a simple moving average value calculation.

To be more specific, if the pixel value of the focused pixel is a and the pixel data of the four adjacent pixels surrounding the focused pixel are b, c, d, and e in order around the focused pixel, the pixel values of the four interpolating pixels a0, a1, a2, a3 are calculated using a0=(8a+b−e)/8, a1=(8a+c−d)/8, a2=(8a+d−c)/8, a3=(8a+e−b)/8. These methods can realize the processing at high speed and double both the horizontal resolution and the vertical resolution with simple circuit configurations.

### DISCLOSURE OF THE INVENTION

However, the technology disclosed in patent document 1 is limited to calculating the pixel values for the interpolating pixels by a simple moving average calculation using only three adjacent pixels in the case that the above-described special group of coefficients {−1, 8, 1} are used in the moving average calculation.

This special coefficient group {−1, 8, 1} corresponds to a part of the filter coefficients {−1, 1, 8, 8, 1, −1} disclosed in FIG. 1 of International Publication No. WO 2004/079905. The moving average calculation using the sequence of filter coefficients is expressed as shown in FIG. 1A. As seen in FIG. 1A, when the interpolation calculation is performed using the coefficient sequence {−1, 1, 8, 8, 1, −1}, it is always possible to obtain the interpolation pixel values by a moving average calculation using the group of three coefficients {−1, 8, 1}, which is to say using only three pixel values.

Another possibility is to perform interpolation calculation using a coefficient sequence {−1, 0, 9, 16, 9, 0, −1}. The moving average calculation using this coefficient sequence is expressed as shown in FIG. 1B. As is clear in FIG. 1B, when the interpolation calculation is performed using the coefficient sequence {−1, 0, 9, 16, 9, 0, −1}, the interpolation pixel values have to be calculated by a moving average calculation which uses the group of four coefficients {−1, 9, 9, −1}, which is to say four pixel values.

When the moving average calculation is performed using other sequences of coefficients shown in FIG. 1 of International Publication No. WO 2004/079905, a larger number of pixel values may be required. In order to use pixel values from the focused pixel and a plurality of adjacent pixels which surround the focused pixel in a moving average calculation, a frame memory with a large capacity is necessary. Further more, since the frame memories as many as the number of the pixel values used in the moving average calculation are required, a problem that a circuit scale became enlarged was occurred. Moreover, there was a problem that the calculation processing became more complex which unable the interpolation process to be performed at high speed.

The present invention was achieved to solve these problems, and has the object of enabling interpolation process using various coefficient sequences to be implemented at high speed using a simple circuit construction.

To solve the above-described problems, the interpolation process circuit of the present invention includes a three-tap FIR calculating part configured to output the sum of products resulting from multiplying data outputted from three taps in a tapped delay line by corresponding filter coefficients made up of a sequence of values in the ratio “−1, m, −1” and an n-tap FIR calculating part configured to output the sum of products resulting from multiplying data outputted from n taps in a tapped delay line by corresponding filter coefficients made up of a sequence of values obtained by performing a moving average calculation (n−1) times on “1”. The three-tap FIR calculating part and the n-tap FIR calculating part are then cascade connected.

In another aspect of the present invention, an emphasis calculating part is included for performing emphasis calculations in a relationship of “−1+kα, m−2kα, −1+kα” (where k may be any number) based on an inputted emphasis coefficient α on filter coefficients comprised of a numeric sequence in the ratio “−1, m, −1” in the three-tap FIR calculating part. The emphasis calculating part may perform emphasis calculations in a relationship of “x+kα, y−2kα, z+kα (where k may be any number) on the three pieces of data “x, y, z” sequentially outputted from the three-tap FIR calculating part.

According to the present invention having the above-described constructions, interpolation values can be obtained by a sum-of-products using various coefficient sequences with a combination of the three-tap FIR calculating part and n-tap FIR calculating part. Specifically, by changing the values of m and n, it is possible to calculate interpolation values by a sum-of-products using various coefficient sequences rather than being limited to specific coefficient sequences.

Moreover, the three-tap FIR calculating part at the input stage is always capable of calculating interpolation values by a sum-of-products using only three values, and therefore its calculation circuit can be small in scale. Moreover, if large capacity memories are required for the delay, three memories at most are sufficient in the present invention. As a result, the circuit can be small in scale. Since the number of taps to be used is very small, the calculation processing is simplified and the high speed interpolation process can be realized.

According to another characteristic of the present invention, the degree of emphasis on the three values used when performing the sum-of-products in the three-tap FIR calculating part can be easily varied using the emphasis coefficient α, and interpolation values can therefore be simply calculated with a sum-of-products using a wider variety of coefficient sequences.

### BRIEF DESCRIPTION OF THE DRAWINGS

FIGS. 1A and 2B show details of moving average calculations of coefficient sequences;

FIG. 2 shows an example construction of an interpolation process circuit according to a first embodiment;

FIG. 3 shows an example of filter coefficients applied in an n-tap FIR calculating part according to any of first to third embodiments;

FIGS. 4A and 4B show details of calculations when a unit pulse of amplitude “1” is inputted to the interpolation process circuit shown in FIG. 2;

FIG. 5 shows another example construction of an interpolation process circuit according to the first embodiment;

FIG. 6 shows details of calculations when a unit pulse of amplitude “1” is inputted to the interpolation process circuit shown in FIG. 5;

FIG. 7 shows another example construction of an interpolation process circuit according to the first embodiment;

FIG. 8 shows details of calculations when a unit pulse of amplitude “1” is inputted to the interpolation process circuit shown in FIG. 7;

FIG. 9 shows an example of coefficient sequences used by the interpolation process circuit according to any of the first to third embodiments;

FIG. 10 shows an impulse response of the coefficient sequences shown in FIG. 9;

FIG. 11 shows an example construction of an interpolation process circuit according to the second embodiment;

FIG. 12 shows details of calculations when a unit pulse of amplitude “1” is inputted to the interpolation process circuit shown in FIG. 11;

FIGS. 13A and 13B show emphasized characteristics in the response waveform obtained when a square wave is inputted to the interpolation process circuit shown in FIG. 11;

FIGS. 14A and 14B show details of calculations when a unit pulse of amplitude “1” is inputted to the interpolation process circuit shown in FIG. 11 after changing the construction of the n-tap FIR calculating part;

FIG. 15 shows an example construction of a two-dimensional interpolation process circuit according to the third embodiment;

FIG. 16 illustrates various clock types used in the two-dimensional interpolation process circuit according to the third embodiment;

FIG. 17 shows a positional relationship of input data used for an interpolation calculation in the two-dimensional interpolation process circuit according to the third embodiment; and

FIG. 18 shows example details of calculation when the input is not oversampled data.

### DETAILED DESCRIPTION OF THE PREFERRED EMBODIMENTS

### First Embodiment

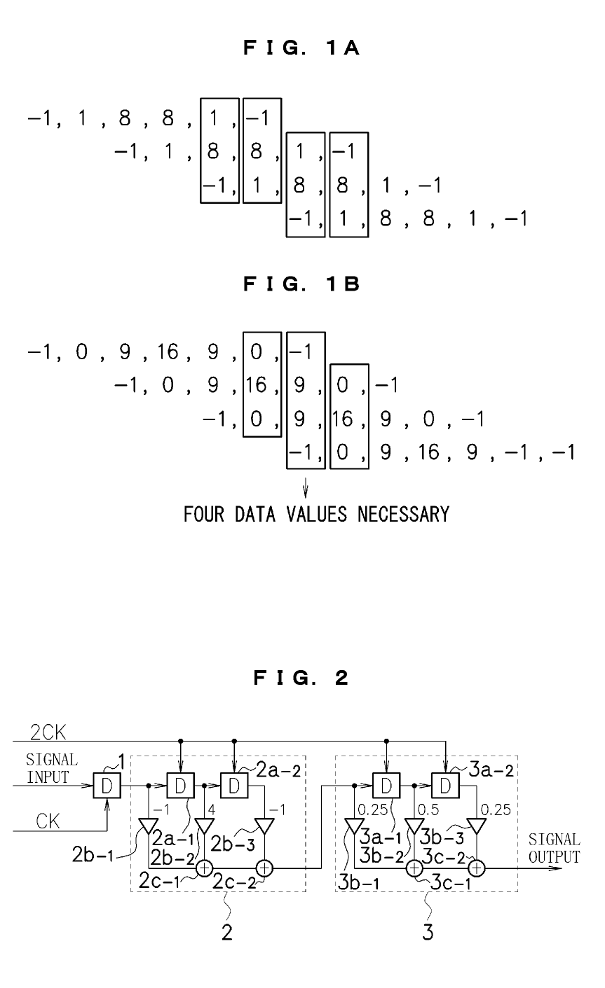

The following describes a first embodiment of the present invention based on the drawings. FIG. 2 shows an example construction of an interpolation process circuit according to the first embodiment. As shown in FIG. 2, the interpolation process circuit of the first embodiment includes a D-type flip-flop 1, a three-tap FIR calculating part 2, and an n-tap FIR calculating part 3.

The D-type flip-flop 1 in the input stage functions as a buffer to hold input data for a single clock CK cycle. The three-tap FIR calculating part 2 sequentially delays input data outputted from the D-type flip-flop 1 using a tapped delay line made up of a plurality of delay devices, multiplies pieces of data outputted from the three taps in the tapped delay line by corresponding filter coefficients from an array of values in the ratio “−1, m, −1” (where m may be any number), and subsequently outputs a sum of the resulting products.

The three-tap FIR calculating part 2 is constructed from two cascade connected D-type flip-flops 2a₋₁ and 2a₋₂, three coefficient devices 2b₋₁ to 2b₋₃, and two adders 2c₋₁ and 2c₋₂. The two D-type flip-flops 2a₋₁ and 2a₋₂ sequentially delay the input data by a single clock (2CK) cycle. The clock (2CK) is a clock with a frequency which is double the frequency of the clock CK. Sequentially delaying the input data by 1 clock (2CK) cycle means that the input data is two-times oversampled.

The three coefficient devices 2b₋₁ to 2b₋₃ form products of the three pieces of data from the input/output taps of the D-type flip-flops 2a₋₁ and 2a₋₂ and the corresponding filter coefficients from the array of values provided in the ratio “−1, m, −1”. The two adders 2c₋₁ and 2c₋₂ add all the data outputted from the coefficient devices 2b₋₁ to 2b₋₃ and output the result. Note that in FIG. 2, the values {−1, 4, −1} are used as examples of the filter coefficients in the coefficient devices 2b₋₁ to 2b₋₃.

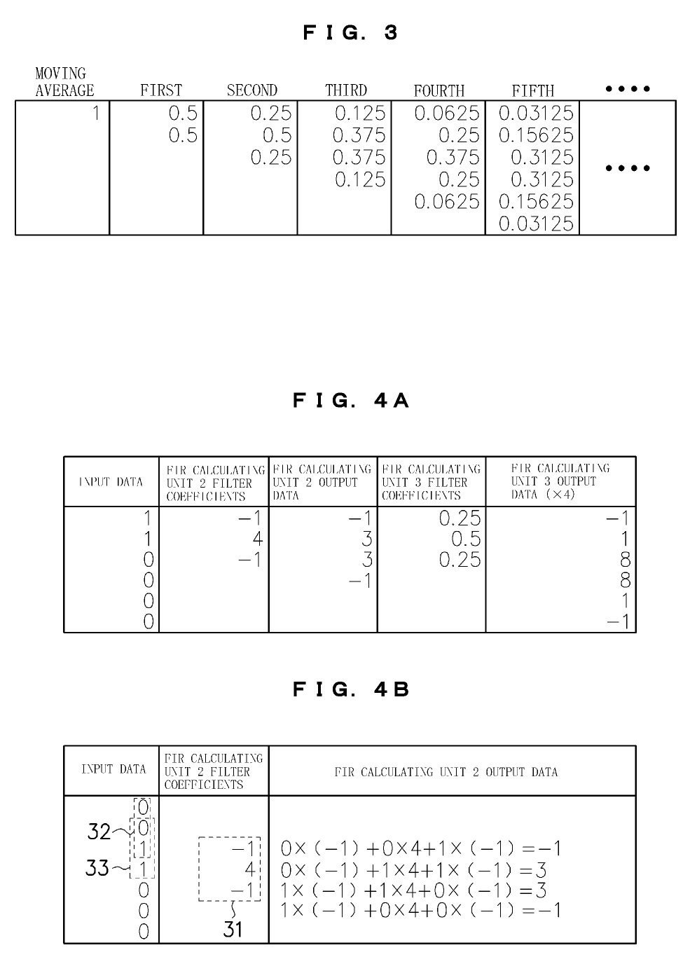

The n-tap FIR calculating part 3 sequentially delays output data from the three-tap FIR calculating part 2 using a tapped delay line made up of a plurality of delay devices, multiplies pieces of data outputted from the n taps (where n is a natural number) in the tapped delay line by corresponding filter coefficients comprised of a prescribed sequence, and subsequently outputs a sum of the resulting products. Here, it is preferable that the prescribed sequence is obtained by (n−1) moving average calculations on “1”. In the example of FIG. 2, a sequence {0.25, 0.5, 0.25} obtained by performing the moving average calculation twice (n=3) on “1” is used as filter coefficients (see FIG. 3).

Here, the moving average to obtain an nth sequence refers to a calculation that is a weighted addition of the (n−1)th sequence and the (n−1)th sequence displaced by one sample (one clock) (with the total value of the weights being “1”). In other words, to obtain the jth filter coefficient in the nth sequence using the moving average calculation, a weighted sum of the jth data in the (n−1)th data sequence and the jth data in the (n−1)th data sequence that has been displaced by one sample is calculated.

For instance, the first value “0.5” at the start of the second sequence is obtained by calculating the sum of the first value in the first sequence, which is original data “1”, and preceding data “0” from one sample before and dividing by two. The second value “0.5” is obtained by calculating the sum of the second original data “0” in the first sequence and the preceding data “1” from one sample before and dividing by two. Note also, the first value “0.25” at the top of the third sequence is obtained by calculating the sum of the first value in the second sequence, which is the original data “0.5”, and the preceding data “0” from one sample before and dividing by two. The second value “0.5” is obtained by calculating the sum of the second original data “0.5” in the second sequence and the preceding data “0.5” from one sample before and dividing by two. The third value “0.25” is obtained by calculating the sum of the third original data “0” in the second sequence and the preceding data “0.5” from one sample before and dividing by two.

The n-tap FIR filter 3 is constructed from two cascade connected D-type flip-flops 3a₋₁ and 3a₋₂, three coefficient devices 3b₋₁ to 3b₋₃ and two adders 3c₋₁ to 3c₋₂. Each of the two D-type flip-flops 3a₋₁ and 3a₋₂ sequentially delays data inputted from the three-tap FIR calculating part by one clock (2CK) cycle. The three coefficient devices 3b₋₁ to 3b₋₃ form products of the three pieces of data from the input/output taps of the D-type flip-flops 3a₋₁ and 3a₋₂, and the corresponding filter coefficients {0.25, 0.5, 0.25}. The two adders 3c₋₁ and 3c₋₂ add all the data outputted from the coefficient devices 3b₋₁ to 3b₋₃ and outputs the result.

FIGS. 4A and 4B show details of calculations performed when a unit pulse of amplitude “1” is inputted to the interpolation process circuit shown in FIG. 2. As shown in FIG. 4A, when a unit pulse is oversampled and inputted to the three-tap FIR calculating part 2, sum-of-products calculations are performed between the input data {1, 1} and filter coefficients {−1, 4, −1} and the sequence of four values {−1, 3, 3, −1} is outputted.

The specific details of sum-of-product calculations performed in the three-tap FIR calculating part 2 are shown in FIG. 4B. Specifically, the filter coefficients of the three-tap FIR calculating part are fixed as the sequence of three values {−1, 4, −1} in the sum-of-product calculations. The input data, on the other hand, is the sequence {1, 1} which is assumed to be preceded and followed by sequences of “0”, and a three-value sequence (the same number as that of filter coefficients for the three-tap FIR calculating part 2) including “0” is used as the sequence in the sum-of-products calculations. To calculate the ith (i=1, 2, 3, 4) value of the output data from the three-tap FIR calculating part 2, the ith value and the preceding two values of the input data are used in the sum-of-products calculation.

For instance, to calculate the first value of the output data from the three-tap FIR calculating part 2, the three filter coefficients {−1, 4, −1} (arrangement surrounded by a dotted line indicated by symbol 31) of the three-tap FIR calculating part 2 and the value sequence {0, 0, 1} (arrangement surrounded by a dotted line indicated by symbol 32) which includes the first value of the input data and the two values preceding the first value are used and a calculation to obtain the sum of the products of corresponding values in the two arrangements is performed. In this case, the result of the calculation is (0×(−1)+0×4+1×(−1))=−1.

Then, to calculate the second value of the output data from the three-tap FIR calculating part 2, the three filter coefficients {−1, 4, −1} (arrangement surrounded by a dotted line indicated by symbol 31) of the three-tap FIR calculating part 2 and the three-value sequence {0, 1, 1} (arrangement surrounded by a dotted line indicated by symbol 33) which includes the second value of the input data and the two values preceding the second value are used and a calculation to obtain the sum of the products of corresponding values in the two arrangements is performed. In this case, the result of the calculation is (0×(−1)+1×4+1×(−1))=3. In the same way, the third value of the output data from the three-tap FIR calculating part 2 is calculated to be (1×(−1)+1×4+0×(−1))=3, and the fourth value is calculated to be (1×(−1)+0×4+1×(−1))=−1.

When the four data values {−1, 3, 3, −1} are inputted, the n-tap FIR calculating part 3 performs sum-of-products calculations between the four data values and the filter coefficients {0.25, 0.5, 0.25} and outputs a sequence in the ratio {−1, 1, 8, 8, 1, −1} (in FIG. 4, values are expressed as integers by multiplying the actually obtained sequences by four). The specific sum-of-product calculations performed in the n-tap FIR calculating part 3 are the same as those shown in FIG. 4B.

Specifically, the filter coefficients of the n-tap FIR calculating part 3 form the fixed three-value sequence {0.25, 0.5, 0.25} used in the sum-of-product calculations. The output data from the three-tap FIR calculating part 2, on the other hand, is the sequence {−1, 3, 3, −1} that is assumed to be preceded and followed by sequences of “0” and a three-value sequence (the same number as that of filter coefficients in the n-tap FIR calculating part 3) including “0” is used as the sequence in the sum-of-products calculations. To calculate the ith value of the output data from the n-tap FIR calculating part 3, the ith value of the output data from the three-tap FIR calculating part 2 and the preceding two values of the output data are used in the sum-of-products calculation.

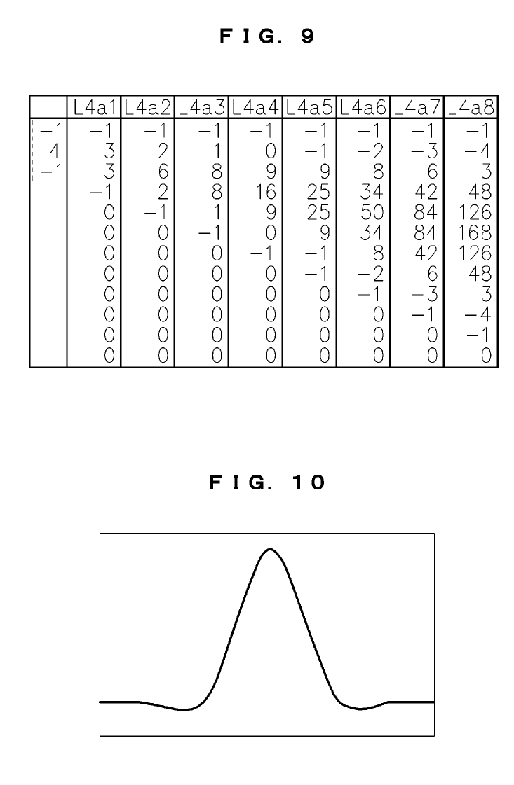

As is clear from the above, the interpolation process circuit shown in FIG. 2 corresponds to a circuit which executes interpolation calculations using a sequence of values in the ratio {−1, 1, 8, 8, 1, −1} (a circuit which converts, when the input data is a unit pulse, the data value “1” to interpolation values {−1, 1, 8, 8, 1, −1}/4, and outputs the interpolation values). The input data used in the interpolation calculations always has three values. This coefficient sequence {−1, 1, 8, 8, 1, −1} corresponds to the coefficient sequence for L4a3 shown in FIG. 1 of International Publication No. WO 2004/079905 (and reproduced in FIG. 9 of the present application).

Here, the following describes slight changes to configurations of the n-tap FIR calculating part 3. For instance, as shown in FIG. 5, an extra one of each D-type flip-flop, coefficient device, and adder are provided to form an n-tap FIR calculating part 4 that includes three cascade-connected D-type flip-flops 4a₋₁ to 4a₋₃, four coefficient devices 4b₋₁ to 4b₋₄, and three adders 4c₋₁ to 4c₋₃. A sequence of {0.125, 0.375, 0.375, 0.125} is used for the filter coefficients of the four coefficient devices 4b₋₁ to 4b₋₄. This sequence is the one obtained by a three-times (n=4) moving average calculation on “1”, as shown in FIG. 3.

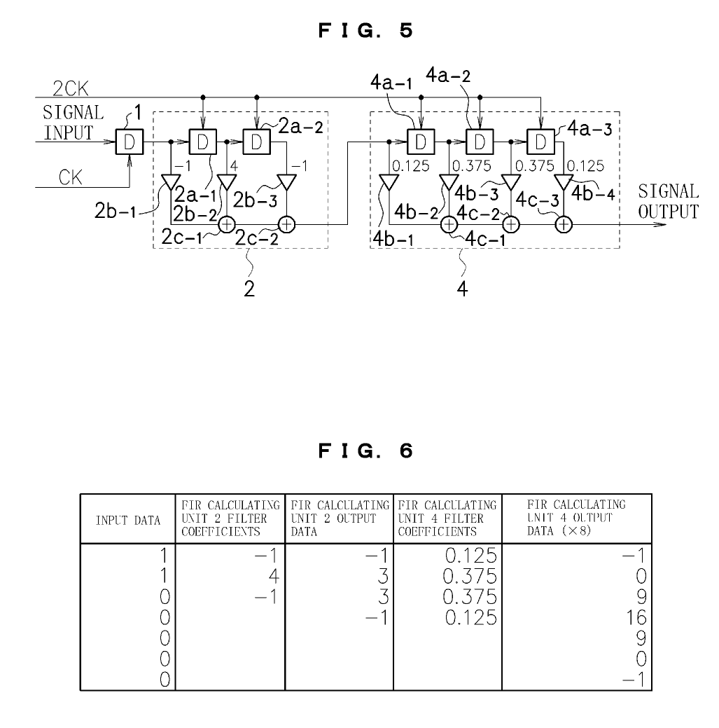

FIG. 6 shows details of a calculation when a unit pulse of amplitude “1” is inputted to the interpolation process circuit shown in FIG. 5. As shown in FIG. 6, when a unit pulse is oversampled and inputted to the three-tap FIR calculating part 2 sum-of-products calculations are performed between the input data “1, 1” and the filter coefficients {−1, 4, −1} and the sequence of four values {−1, 3, 3, −1} is outputted. Thus far, the calculation is the same as when the n-tap FIR calculating part 3 shown in FIG. 2 is used.

Further, when the four-value data {−1, 3, 3, −1} outputted from the three-tap FIR calculating part 2 is inputted to the next stage, the n-tap FIR calculating part 4 performs sum-of-products calculations between the four data values and the filter coefficients {0.125, 0.375, 0.375, 0.125} and outputs the resulting sequence in the ratio {−1, 0, 9, 16, 9, 0, −1} (in FIG. 6, values are expressed as integers by multiplying the actually obtained sequences by eight).

As is clear from the above, the interpolation process circuit shown in FIG. 5 corresponds to a circuit which executes interpolation calculations using a coefficient sequence in the ratio {−1, 0, 9, 16, 9, 0, −1}. The input data used in the interpolation calculations always has three values in the same manner as the interpolation process circuit shown in FIG. 2. The coefficient sequence {−1, 0, 9, 16, 9, 0, −1} corresponds to the coefficient sequence for L4a4 shown in FIG. 9. Hence, the use of the interpolation process circuit shown in FIG. 5 allows interpolation calculations to be performed based on a coefficient sequence that differs from the case shown in FIG. 2 by using input data including only three values in the same way as in FIG. 2.

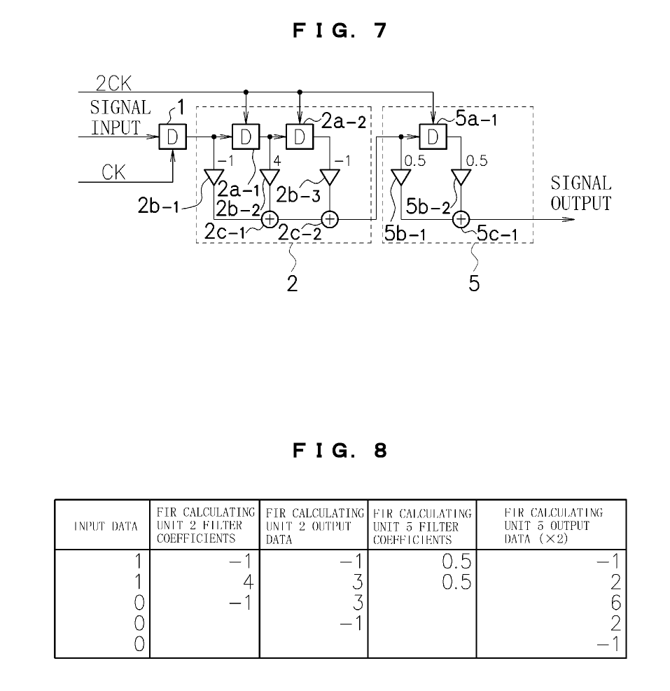

Furthermore, the construction including an n-tap FIR calculating part 5 shown in FIG. 7 will be described. In the example of FIG. 7, one of each D-type flip-flop, coefficient device, and adder is omitted so as to form an n-tap FIR calculating part 5 that includes a single D-type flip-flop 5a₋₁, two coefficient devices 5b₋₁, and 5b₋₂, and one adders 5c₋₁. A sequence of {0.5, 0.5} is used for the filter coefficients of the two coefficient devices 5b₋₁ and 5b₋₂. This sequence is the one obtained by a single (n=2) moving average calculation on “1” as shown in FIG. 3.

FIG. 8 shows details of a calculation when a unit pulse of amplitude “1” is inputted to the interpolation process circuit shown in FIG. 7. As shown in FIG. 8, when a unit pulse is oversampled and inputted, the three-tap FIR calculating part 2 performs sum-of-products calculations between the input data “1, 1” and the filter coefficients {−1, 4, −1}, and outputs the four-value sequence {−1, 3, 3, −1}. Thus far, the calculation is the same as when the n-tap FIR calculating part 3 shown in FIG. 2 is used.

Further, when the four-value data {−1, 3, 3, −1} outputted from the three-tap FIR calculating part 2 is inputted to the next stage, the n-tap FIR calculating part 5 performs sum-of-products calculations between the four data values and the filter coefficients {0.5, 0.5} and outputs the resulting sequence in the ratio {−1, 2, 6, 2, −1} (in FIG. 8, values are expressed as integers by multiplying the actually obtained sequences by two). As is clear from the above, the interpolation process circuit shown in FIG. 7 corresponds to a circuit which executes interpolation calculations using a sequence of values in the ratio {−1, 2, 6, 2, −1}. The input data used in the interpolation calculations always has three values.

As described in detail above, according to the first embodiment, data interpolation using the various coefficient sequences shown in FIG. 9 can be performed by sum-of-products calculations that only ever use three input data values. In other words, when any of the sequences shown in FIG. 9 are used in interpolation calculations, the interpolation calculations can be performed with the fixed three-tap FIR calculating part 2 consistently using three input data values. It is then possible to perform interpolation with various coefficient sequences simply by changing the number of taps (the value of n) and the filter coefficient values of the n-tap FIR calculating part of the latter stage.

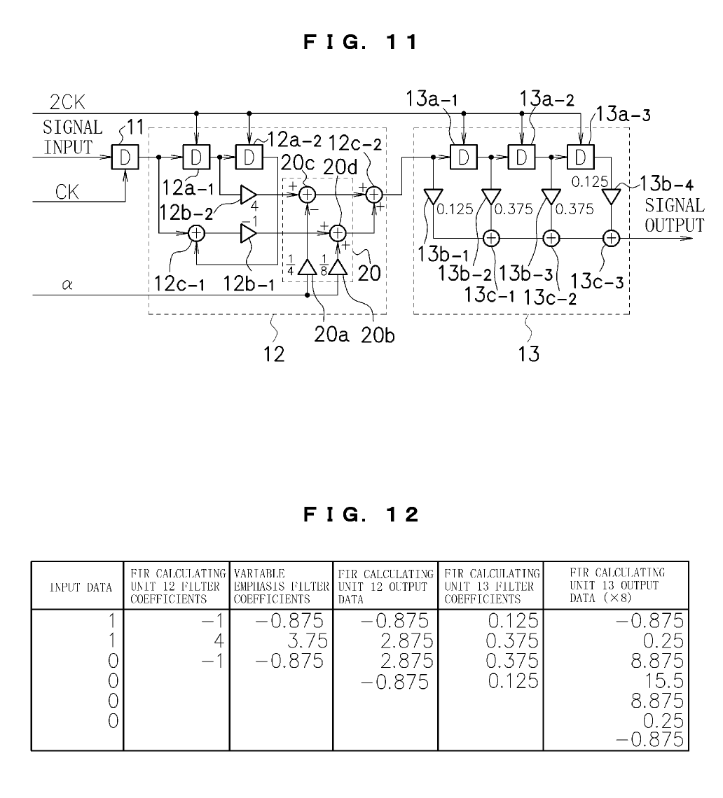

FIG. 10 shows an impulse response (waveform of interpolation function) for the coefficient sequence shown in FIG. 9. The impulse response with a waveform as shown in FIG. 10 is a function which reaches non-zero finite values only when sampling positions along the horizontal axis are in a certain region and becomes “0” in all other regions. In other words, the impulse response is a function which converges on “0” at prescribed sampling positions (this is referred to as a “finite-base” function). All the impulse response of the coefficient sequences shown in FIG. 9 give a finite-base functions.

In this type of finite-base impulse response, only the data within a local region having finite values other than “0” are to be paid attention. The data other than the local region need not be taken into consideration theoretically. It does not mean that the data other than the local region, which should be essentially taken into consideration at the interpolation calculations, is ignored. Therefore, the use of the coefficient sequences shown in FIG. 9 as an interpolation function enables an accurate interpolation value to be obtained preventing truncation errors in the obtained interpolation values, which differs from the sinc function (which converges on 0 at ±∞) generally used in the prior art as an interpolation function. Moreover, according to the first embodiment, data interpolation using various coefficient sequences different from the examples shown in FIG. 9 can, by changing the value of m, be performed using a sum-of-products with only three input data. When the value of m is changed, the impulse response of the obtained coefficient sequence still results in a finite-base function. Therefore, when this type of coefficient sequence is used as an interpolation function, it is possible to calculate accurate interpolation values.

Further, according to the first embodiment, since only three input data are used to calculate the interpolation values, very few taps are required in the interpolation calculation, which results in the circuit with a reduced scale. Moreover, the processing performed by the circuit is extremely simple and so the interpolation process can be performed at high speed.

The interpolation process circuit of the above-describe first embodiment can be used to calculate the interpolation values from three consecutively inputted pieces of data. For instance, when the interpolation process circuit of the present embodiment is used as an image resolution improving circuit for improving the quality of television images, it is possible to obtain the interpolation pixel values by performing the sum-of-products calculations on three pixel values consecutively existing in a horizontal line. In other words, the use of the interpolation process circuit according to the first embodiment allows one-dimensional interpolation process of television images to be performed.

### Second Embodiment

The following describes the second embodiment of the present invention. FIG. 11 shows an example construction of an interpolation process circuit according to the second embodiment. As shown in FIG. 11, the interpolation process circuit of the second embodiment includes a D-type flip-flop 11, a three-tap FIR calculating part 12, an n-tap FIR calculating part 13, and an emphasis calculating part 20.

The D-type flip-flop 11 in the input stage functions as a buffer to hold input data for a single clock CK cycle. The three-tap FIR calculating part 12 sequentially delays input data outputted from the D-type flip-flop 11 using a tapped delay line made up of a plurality of delay devices, multiplies pieces of data outputted from the three taps in the tapped delay line by corresponding filter coefficients from an array of values in the ratio “−1, m, −1” (where m may be any number), and subsequently outputs a sum of the resulting products.

The three-tap FIR calculating part 12 of the second embodiment includes two cascade connected D-type flip-flops 12a₋₁ and 12a₋₂, two coefficient devices 12b₋₁ and 12b₋₂, and two adders 12c₋₁ and 12c₋₂. Although the three-tap FIR calculating part 12 constructed in this way is slightly different from the three-tap FIR calculating part 2 shown in the first embodiment, the details of sum-of-products to be executed is exactly the same.

The differences in the construction are as follows. In the above-described first embodiment, the data outputted from the input tap of the D-type flip-flop 2a₋₁ in the first stage, and the data outputted from the output tap of the D-type flip-flop 2a₋₂ in the second stage are multiplied by a filter coefficient of −1, respectively, and the resulting products are then added.

On the other hand, in the second embodiment, the data outputted from the input tap of the D-type flip-flop 12a₋₁ in the first stage and the data outputted from the output tap of the D-type flip-flop 12a₋₂ in the second stage are first added using the adder 12c₋₁ and the resulting value is then multiplied by a filter coefficient of −1 using the coefficient device 12b₋₁.

In other words, the coefficient device 12b₋₁ shown in FIG. 11 serves as the two coefficient devices 2b₋₁ and 2b₋₃ shown in FIG. 2. This allows the number of coefficient devices to be reduced, resulting in the downsized circuit in scale. Note that in the above-described first embodiment, the three-tap FIR calculating part 2 may have the same construction as the three-tap FIR calculating part 12 shown in FIG. 11.

The emphasis calculating part 20 including coefficient devices 20a and 20b, a subtractor 20c, and an adder 20d performs an emphasis calculation in a relationship of “−1+α/8, m−α/4, −1+α/8” on filter coefficients made up of the sequence in the ratio “−1, m, −1” in the three-tap FIR calculating part 12 based on an inputted emphasis coefficient α (where α may be any number). In this emphasis calculation, the same value (α/8 in the above-described case) is added to the coefficient values on both sides and the total of added values (α/4 in the above-described case) is subtracted from the center coefficient value. With these methods, the sum of the coefficient sequence is remained unchanged before and after emphasis (−1+m+(−1)=m−2, (−1+α/8)+(m−α/4)+(−1+α/8)=m−2).

In the emphasis calculating part 20, the coefficient device 20a multiplies an inputted emphasis coefficient α by the coefficient ¼. Further, the subtractor 20c subtracts the data outputted from the coefficient device 20a from the data outputted from the coefficient device 12b₋₂ which multiplies by the filter coefficient corresponding to “m” to obtain the result m−α/4. The coefficient device 20b multiplies the inputted emphasis coefficient α by the coefficient ⅛. The adder 20d adds the data outputted from the coefficient device 12b₋₁ which multiplies by the filter coefficients corresponding to “−1, −1” among “−1, m, −1” to the data outputted from the coefficient device 20b to obtain the result −1+α/8.

The n-tap FIR calculating part 13 sequentially delays data, on which the emphasis calculating part 20 has performed the emphasis calculation based on the emphasis coefficient α, outputted from the three-tap FIR calculating part 12 using the tapped delay line made up of a plurality of delay devices, multiplies pieces of data outputted from the four taps in the tapped delay line by corresponding filter coefficients of the sequence {0.125, 0.375, 0.375, 0.125} as shown in FIG. 3, and outputs a sum of the resulting products.

The construction of the n-tap FIR calculating part 13 is the same as that of the n-tap FIR calculating part 4 in FIG. 5. Note that with regard to the n-tap FIR calculating part 13, it is possible to reduce the number of coefficient devices by using a construction in which the filter coefficients are added before performing the multiplication in the same way as in the three-tap FIR calculating part 12. Note also that, in the above-described first embodiment, a construction may be used in which the number of coefficient devices in the n-tap FIR calculating parts 3, 4, and 5 has been reduced by one in the same way as in the three-tap FIR calculating part 12.

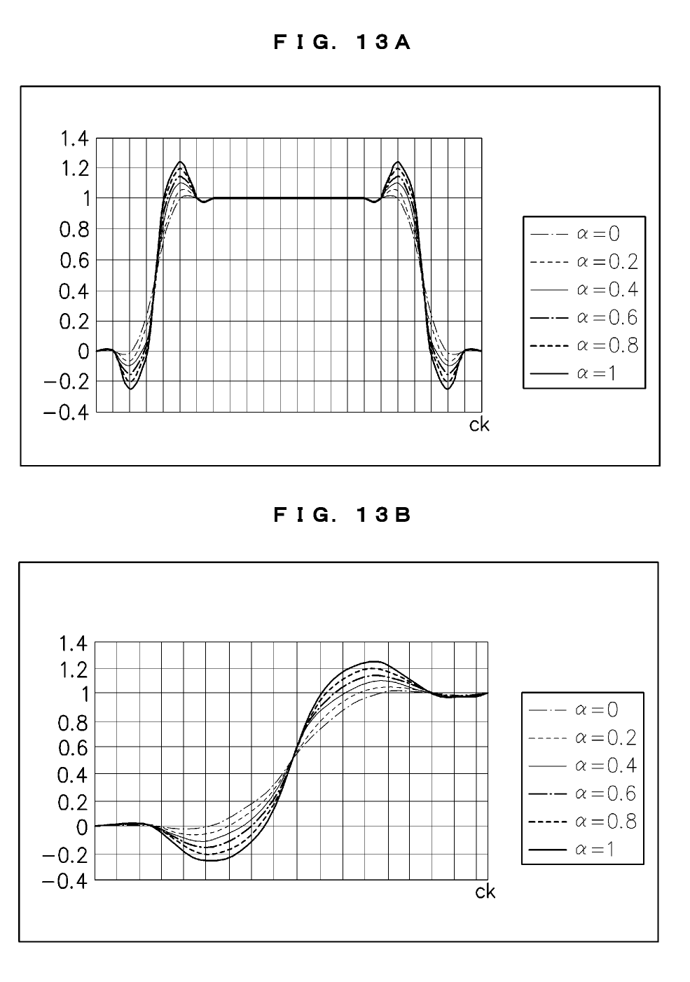

FIG. 12 shows details of calculations performed when a unit pulse of amplitude “1” is inputted to the interpolation process circuit shown in FIG. 11. Here the emphasis coefficient α is set to “1”. As shown in FIG. 12, when the value of the emphasis coefficient α is “1”, the filter coefficients {−1, 4, −1} of the three-tap FIR calculating part 12 become {−0.875, 3.75, −0.875} as a result of the emphasis calculation in a relationship of “−1+α/8, 4−α/4, −1+α/4”.

The three-tap FIR calculating part 12 therefore performs a sum-of-products between the emphasized filter coefficients {−0.875, 3.75, −0.875} and the oversampled input data “1, 1” and outputs a four-value sequence of {−0.875, 2.875, 2.875 −0.875}. When the four data values are inputted, the n-tap FIR calculating part 13 performs sum-of-products calculations between the four data values and the filter coefficients {0.125, 0.375, 0.375, 0.125} and outputs a sequence in the ratio {−0.875, 0.25, 8.875 15.5, 8.875, 0.25, −0.875}. Note that when α=0, a sequence of values in the ratio {−1, 0, 9, 16, 9, 0, −1}, which is the same as in FIG. 6 is obtained.

As is clear from the above, the interpolation process circuit shown in FIG. 11 executes interpolation process using a coefficient sequence with the ratio {−0.875, 0.25, 8.875, 15.5, 8.875, 0.25, −0.875}. Here, though not shown in the drawings, the obtained coefficient sequence changes when the value of the emphasis coefficient α is varied. Thus, according to the second embodiment, the change of the value of the emphasis coefficient α allows data interpolation using various coefficient sequences to be performed by product-sum calculations only ever using three input data values without changing the configuration of the interpolation process circuit.

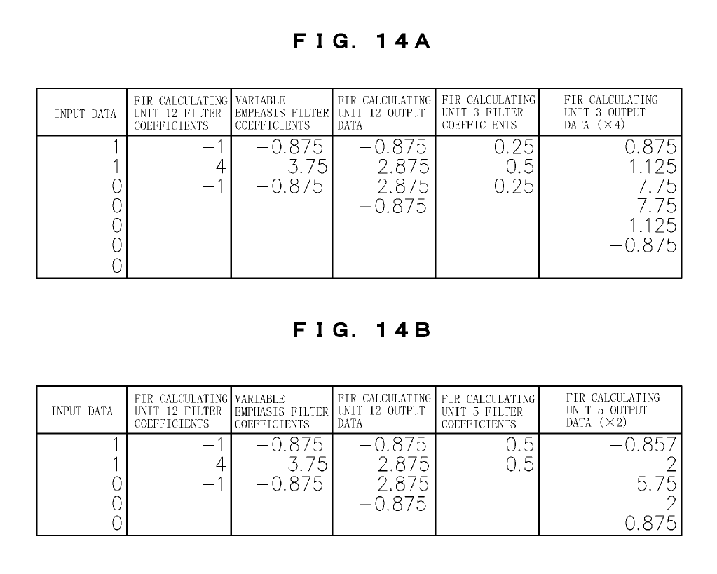

FIGS. 13A and 13B show emphasized characteristics in the response waveform obtained when a square wave is inputted to the interpolation process circuit shown in FIG. 11. FIG. 13A shows the overall response waveform and FIG. 13B shows an enlarged portion of the response waveform. As shown in FIG. 13, when the value of the emphasis coefficient α is 0, a square wave response with very few overshoots and undershoots can be obtained. On the other hand, when the value of the emphasis coefficient α is larger than “0”, overshoot and undershoot occur. The larger the value of the emphasis coefficient α, the larger the overshoots and undershoots become.

Note that, as described above, the sequence “−1, m, −1” has a finite-base impulse response. The impulse response of the sequence “−1+α/8, m−α/4, −1+α/8” obtained by the emphasis calculation using the emphasis coefficient α to the sequence having such characteristics is the finite-base function even if its amplitude is changed depending on the emphasis coefficient α (see FIG. 13).

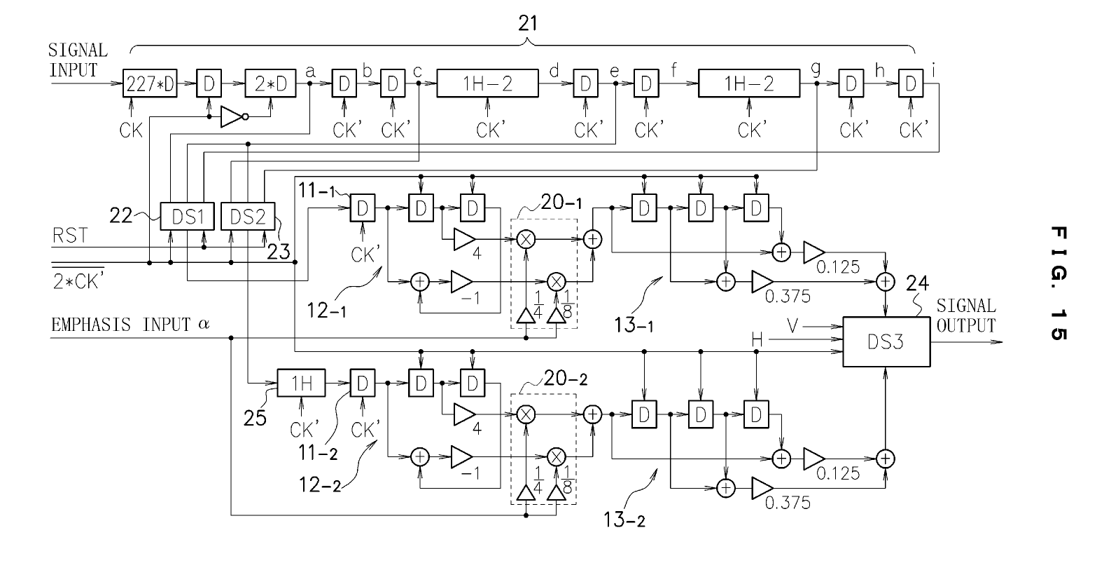

Also, in the second embodiment, it is possible to change the coefficient sequences used in the interpolation calculation by changing the construction of the n-tap FIR calculating part 13. At this point, the three-tap FIR calculating part 12 is fixed, and it is possible to perform interpolation using various coefficient sequences with only three input data values consistently. FIGS. 14A and 14B show the calculations when the n-tap FIR calculating part 13 has the same construction as the n-tap FIR calculating part 3 shown in FIG. 2 or the n-tap FIR calculating part 5 in FIG. 7. In the example of FIG. 14, the emphasis coefficient α is also set to “1”.

FIGS. 14A and 14B show the calculations when each configuration has been changed to form the n-tap FIR calculating part 3 and to form the n-tap FIR calculating part 5, respectively. As shown in FIG. 14A, in the interpolation process circuit shown in FIG. 11 with the n-tap FIR calculating part 13 altered to the n-tap FIR calculating part 3 and α=1, interpolation calculations can be performed using the coefficient sequence {−0.875, 1.125, 7.75, 7.75, 1.125, −0.875}. As shown in FIG. 14B, in the interpolation process circuit shown in FIG. 11 with the n-tap FIR calculating part 13 altered to form the n-tap FIR calculating part 5 and α=1, interpolation calculations can be performed using the coefficient sequence {−0.875, 2, 5.75, 2, −0.875}.

As described in detail above, the second embodiment also allows data interpolation using various coefficient sequences to be performed by sum-of-products calculations that only ever use three input data values. Moreover, the strength of the emphasis for the three values used in the sum-of-products calculation in the three-tap FIR calculating part can be easily changed using the emphasis coefficient α, thereby interpolation values can be easily obtained by sum-of-products calculations using a wider variety of coefficient sequences. Furthermore, since the number of taps is extremely small, the scale of the circuit can be downsized. Also, since the processing is very simple, the interpolation process can be performed at high speed.

The present invention is not limited to the described example wherein the emphasis calculation is performed in a relationship of “−1+α/8, m−α/4, −1+α/8” on filter coefficients comprised of a sequence in the ratio “−1, m, −1” in the three-tap FIR calculating part 12. Provided that the total value of the coefficients in the sequence is unchanged before and after the emphasis, emphasis calculations other than the one described may be used. For instance, it is possible to perform emphasis calculations in a relationship of “−1+kα, m−2kα, −1+kα” (where k may be any number). Alternatively, when three pieces of data sequentially outputted from the three-tap FIR calculating part are denoted by “x, y, z”, the emphasis calculating part may perform emphasis calculations in a relationship of “x+kα, y−2kα, z+kα” on the three pieces of output data “x, y, z”.

### Third Embodiment

The following describes the third embodiment of the present invention. In the above first and second embodiments, examples of one-dimensional interpolation process circuits for calculating interpolation values from three consecutively inputted pieces of data are described. In the third embodiment below, an example of a two-dimensional interpolation process circuits for calculating interpolation values from three discrete pieces of data is described. For instance, when the interpolation process circuit of the present embodiment is used as an image resolution improving circuit for improving the quality of television images, it is possible to obtain the interpolation pixel values from three pixel values discretely existing in three horizontal lines.

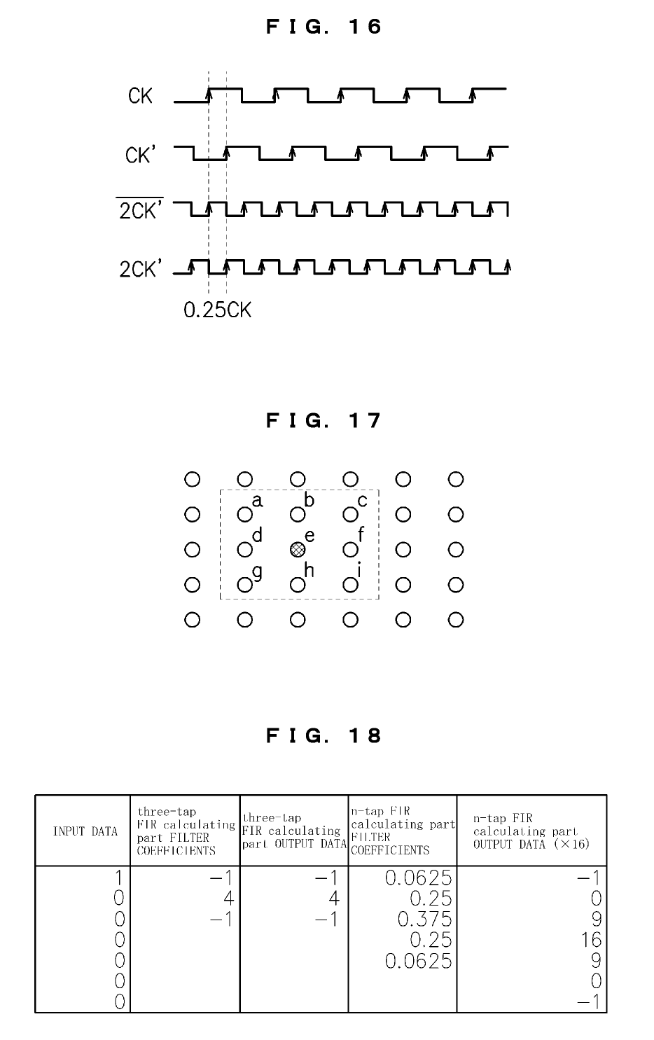

FIG. 15 shows an example construction of a two-dimensional interpolation process circuit according to the third embodiment which is applied to television images in order to improve the resolution. FIG. 16 shows various clocks used in the two-dimensional interpolation process circuit according to the third embodiment. FIG. 17 shows a positional relationship of input data used for interpolation calculations in the two-dimensional interpolation process circuit according to the third embodiment.

As shown in FIG. 15, the two-dimensional interpolation process circuit of the third embodiment includes a tapped delay line 21, D-type flip-flops (buffers) 11₋₁ and 11₋₂, three-tap FIR calculating parts 12₋₁ and 12₋₂, n-tap FIR calculating parts 13₋₁ and 13₋₂, emphasis calculating parts 20₋₁ and 20₋₂, three data selectors 22, 23, and 24, and a 1H (1 horizontal line) delay circuit 25.

The tapped delay line 21 is constructed from a plurality of delay devices and sequentially delays inputted data. The tapped delay line 21 is formed so as to output data from a plurality of predetermined taps thereon. When the focused pixel is in the pixel position e shown in FIG. 17, the data values outputted from the tapped delay line 21 are the pixel values of the focused pixel e and of the four pixels a, c, g, and i which align diagonally at proximal positions sandwiching the focused pixel e. The amount of delay on the tapped delay line 21 is adjusted so that the data of the pixel values a, c, e, g, and i are outputted from the prescribed taps.

Of the data values outputted from the tapped delay line 21, the pixel values a, e, and i are inputted into the first data selector 22 and outputted sequentially to the three-tap FIR calculating part 12₋₁ via the D-type flip-flop 11₋₁. The pixel values c, e, and g are inputted to the second data selector 23 and outputted sequentially via the 1H delay circuit 25 and the D-type flip-flop 11₋₂ to the three-tap FIR calculating part 12₋₂.

The D-type flip-flops 11₋₁ and 11₋₂ have the same function as the D-type flip-flop 11 shown in FIG. 11. The three-tap FIR calculating parts 12₋₁ and 12₋₂ have the same function as the three-tap FIR calculating part 12 shown in FIG. 11. The n-tap FIR calculating parts 13₋₁ and 13₋₂ have the same function as the n-tap FIR calculating part 13 shown in FIG. 11. Moreover, the emphasis calculating parts 20₋₁ and 20₋₂ have the same function as the emphasis calculating part 20 shown in FIG. 11. Therefore, the detailed descriptions of these parts are omitted.

Note that although an example is described in which the n-tap FIR calculating parts 13₋₁ and 13₋₂ (n=4) are used, the n-tap FIR calculating part 3 (n=3) shown in FIG. 2, the n-tap FIR calculating part 3 (n=2) shown in FIG. 7, or an n-tap FIR calculating part using another value of n (not shown in drawings) may be used.

The third data selector 24 selects either the data outputted from the first n-tap FIR calculating part 13₋₁ or the data outputted from the second n-tap FIR calculating part 13₋₂ and outputs the selected data. Specifically, for odd clocks on odd lines and odd clocks on even lines, the data outputted from the first n-tap FIR calculating part 13₋₁ is selected. For even clocks on the odd lines and even clocks on the even lines, the data outputted from the second n-tap FIR calculating part 13₋₂ is selected.

According to the third embodiment with this construction, it is possible to construct a two-dimensional interpolation process circuit using tapped delay lines, three-tap FIR calculating parts, and n-tap FIR calculating parts in a basically similar way to the first embodiment. Thus, in any case, by changing the values of m and n, two-dimensional image interpolation process using various coefficient sequences can be performed by a sum-of-products calculation which only ever uses three input data values. Moreover, the strength of the emphasis for the three values used in the sum-of-products calculation in the three-tap FIR calculating part can be easily changed using the emphasis coefficient α, thereby allowing interpolation values to be easily calculated by sum-of-products calculations using a wider variety of coefficient sequences. Furthermore, since the number of taps is extremely small, the scale of the circuit can be downsized. Also, since the processing is very simple, the interpolation process can be performed at high speed.

Note that although in the first to third embodiments examples are described in which interpolation is performed by two-times oversampling of the input data, the present invention is not limited to such an arrangement. For instance, interpolation may be performed using four-times oversampling, eight-times oversampling or some other rate greater than two times. Alternatively, interpolation may be performed without oversampling.

When the input data is not oversampled, it is possible to realize interpolation calculations using the sequence of values shown in the example of FIG. 9. FIG. 18 shows the calculation performed when interpolation process is realized using a sequence of values in the ratio {−1, 0, 9, 16, 9, 0, −1}. As is clear from FIG. 18, when the three-tap FIR calculating part 2 shown in drawings such as FIG. 2 is cascade connected to the n-tap FIR calculating part with n=5 (not shown in the drawings of the present description) and the sequence {0.0625. 0.25, 0.375, 0.25, 0.0625} is used as the filter coefficients in the n-tap FIR calculating part, it is possible to perform an interpolation calculation which uses a sequence in the ratio {−1, 0, 9, 16, 9, 0, −1}.

However, as is clear from a comparison of FIG. 18 and FIG. 6, the use of two-times oversampling of the input data reduces the number of filter coefficients used in the n-tap FIR calculating part. This allows a reduction in the number of taps required for the interpolation calculation and a corresponding reduction in the scale of the circuit, and is therefore favorable.

In the above-described first to third embodiments, examples are described in which the interpolation process circuit is applied as an image resolution improving circuit for improving the quality of television images. However, the present invention is not limited to this application. For instance, it is possible to apply the present invention to a circuit for improving the quality of sound signals, a circuit for decompressing compressed data, and the like. The present invention can further be applied in all circuits in which data interpolation is necessary.

Further, the first to third embodiments are no more than example implementations of the present invention and should not be interpreted as limiting the technical scope of the present invention. Various other implementations are possible without departing from the main characteristics or spirit of the present invention.

### INDUSTRIAL APPLICABILITY

The present invention is useful in an interpolation process circuit utilizing an FIR digital filter of the type that multiplies each tap signal on a tapped delay line made up of a plurality of delay devices by a corresponding filter coefficient and then outputs the sum of these products. The interpolation process circuit of the present invention can be applied to any circuit and apparatus for which data interpolation is necessary.

1. An interpolation process circuit comprising:
a three-tap FIR calculating part configured to sequentially delay input data using a tapped delay line made up of a plurality of delay devices, multiply data outputted from three taps in the tapped delay line by corresponding filter coefficients which form a sequence in the ratio “−1, m, −1” (where m may be any number), and output a sum of resulting products; and
an n-tap FIR calculating part configured to sequentially delay output data from the three-tap FIR calculating part using a tapped delay line made up of a plurality of delay devices, multiply data outputted from the n taps (where n is a natural number) in the tapped delay line by corresponding filter coefficients which form a sequence obtained by calculating a moving average of “1” (n−1) times, and output a sum of resulting products.

2. The interpolation process circuit according to claim 1, further comprising:
an emphasis calculating part configured to perform, based on an inputted emphasis coefficient α (where α may be any number), emphasis calculations in a relationship of “−1+kα, m−2kα, −1+kα” (where k may be any number) for filter coefficients which form a sequence in the ratio “−1, m, −1” in the three-tap FIR calculating part.

3. The interpolation process circuit according to claim 1, further comprising:
an emphasis calculating part configured to perform, based on an inputted emphasis coefficient α (where α may be any number), emphasis calculations in a relationship of “x+kα, y−2kα, z+kα” (where k may be any number) for three pieces of data “x, y, z” sequentially outputted from the three-tap FIR calculating part.
